(19) United States
(12) Patent Application Publication
(10) Pub. No.: US 2014/0358891 A1
(43) Pub. Date: Dec. 4, 2014

(54) SYSTEM FOR COLLECTING, CALCULATING, AND RANKING INTEREST IN INFORMATION IN REAL TIME

(71) Applicant: LISTENER DRIVEN RADIO LLC, Rocky River, OH (US)

(72) Inventors: Daniel Anstandig, Bay Village, OH (US); Brian Seeders, Westlake, OH (US)

(73) Assignee: LISTENER DRIVEN RADIO LLC, Rocky River, OH (US)

(21) Appl. No.: 14/295,631

(22) Filed: Jun. 4, 2014

Related U.S. Application Data
(60) Provisional application No. 61/830,985, filed on Jun. 4, 2013.

(51) Int. Cl. G06F 17/30

(52) U.S. Cl. CPC G06F 17/30864; G06F 17/30699
USPC 707/710

(57) ABSTRACT

A method of measuring multiple digital social interactions around a topic or news story for the purpose of providing real-time insight on which topics are of greater importance to a particular audience. The invention provides the apparatus and structure to collect information deemed to be a topic, to take a set of references to the topic and integrate that into a thread and to place the thread into a pulse category, to calculate the amount of interest in the thread and the growth of interest in the thread as well as the rate of change of the growth of interest and to formulate a rank of the interest which is displayed visually to a consumer by pulse topic.

### FIELD OF THE INVENTION

This Application claims the benefit of priority under 35 U.S.C. §119 of U.S. Provisional Application Ser. No. 61/830,985, filed on Jun. 4, 2013, herein fully incorporated by reference.

The invention relates generally to the hardware and software to provide an automated ability to collect information in real time, such as by performing all or some of the following operations on a set of raw data: scan, filter, analyze, aggregate, tabulate and categorize. These operations are performed on bits of information deemed to be a “topic” which is typically a bit of information such as a news headline, a set of text, a visual image or map bit, or a spoken word, and which is selected according to predefined characteristics based on an end use or defined or perceived consumer interest. The invention can use remote communication means, such as the world wide web, or a locally constructed web or a communication network such as is formed through a social media site such as Facebook® or Twitter®, to gather the information, and the apparatus that acts upon the information can be integrated into a single device or into multiple devices that are linked by wire or wirelessly and that act in conjunction such as in series, or in tandem, or with each other to ingest and digest the information, to tabulate information relating to the information from various sources, and to generate a categorized display of the information to an end user.

### BACKGROUND OF THE INVENTION

Traditionally, content publishers and broadcasters have largely relied on the intuition of their producers to determine which topics are of significant importance or appeal to their audiences. At best, there has only been anecdotal data to shed light on which topics are most resonant with a local or national audience, such as “on the street interviews” or web polls. After all, there was never a way to detect which stories were actively read in a newspaper, heard on the radio, or watched on TV. In the past, broadcasters or publishers would largely depend on the assumed good judgment of services like Associated Press or other news-wire services to detect, report, and prioritize which news stories or topics were most crucial to their constituents.

Now, news breaks outside of broadcast media outlets such as social media. Whitney Houston's passing, the British Royal wedding announcement, Osama bin Laden's death, the miracle landing of a US Air flight on the Hudson river, and many other stories have been released on digital/social media before they hit the airwaves.

In recent years, digital and social media have accelerated our ability to discover and discuss news and conversation topics—and simultaneously, technology has progressed to allow tracking of web traffic and interaction around stories.

Today, digital publishing or news/media oriented websites which collectively constitute a “news source” (such as the on-line versions of the press or news industry, or even user generated content such as chat room and blogs), have greater ability to provide tracking of which pages or stories are attracting the greatest level of traffic. However, a particular story or topic may thread across hundreds of headlines on multiple sites and posts on various social media. Until this invention, there has been no efficient way to harness social data, web traffic and mobile analytics, and interaction data to provide a simple color coded approach to which topics/stories or other similar content have the greatest level of appeal at a given time, and over time with a particular audience.

### SUMMARY OF THE INVENTION

The present invention uses data feeds or a web crawler to collect information on which topics or stories are reported or posted on various websites. When multiple versions of the same topic are found, or multiple posts appear to share the same thread based on semantic or other means of analysis (including for example, SUK, ISBN or bit-mapping analysis for image recognition), the invention performs tasks to group all posts into one thread, and concomitantly performs such tasks on multiple topics. These tasks are performed simultaneously to generate multiple threads. Then, the invention queries various social media services and/or websites to count the number of interactions (including but not limited to retweets, quoted tweets, texts, comments, “likes,” “dislikes” traffic, such as hits or views, or other similar user-generated actions) related to that particular topic.

The context of certain interactions may be evaluated for the purpose of determining whether the story or topic is positively or negatively perceived. For example, tweets, comments, Facebook posts, or other similar interactions may be scanned for identifiable emotional words, such as “hate” or “love.” The queries are done on a repeated basis over time for the purpose of identifying trends in growth related to a topic/story. Then, the invention will provide a summary of all topics detected among a particular audience along with a color coded label to indicate whether the topic is hot, trending, new, flat, or dead. The invention may be used by an online or broadcast content producer, webmaster, author, reporter, etc. to determine which topics should be addressed on-air, online, or via other media.

Thus, the present invention uses a computer means and associated software to collect data relating to topics; to manipulate the data on the topics to determine a thread which involves the same topic or related topics reported such as by different sources, at different times, using different words; multiple threads are followed by the invention; and the invention aggregates, categories, and displays information relating to the threads including a visual indication of the interest, the rank of the level of interest, the growth of the interest, and the rate of growth of interest over time and optionally according to predefined characteristics such as information provider demographics.

### BRIEF DESCRIPTION OF THE DRAWINGS

The invention will be better understood and other features and advantages will become apparent by reading the detailed description of the invention, taken together with the drawings, wherein:

FIG. 1 is a schematic representation of the present invention;

FIG. 2 illustrates a user interface, or dashboard for the invention;

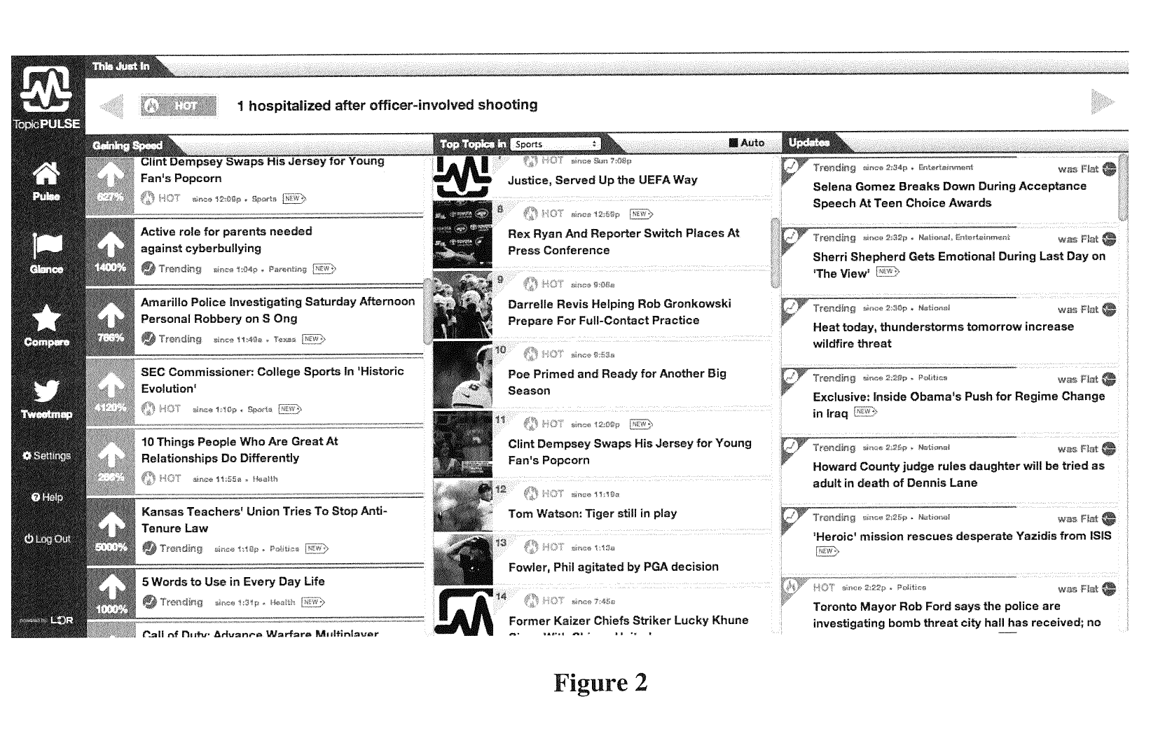

FIG. 3 illustrates the administrative screen displays of the present invention;

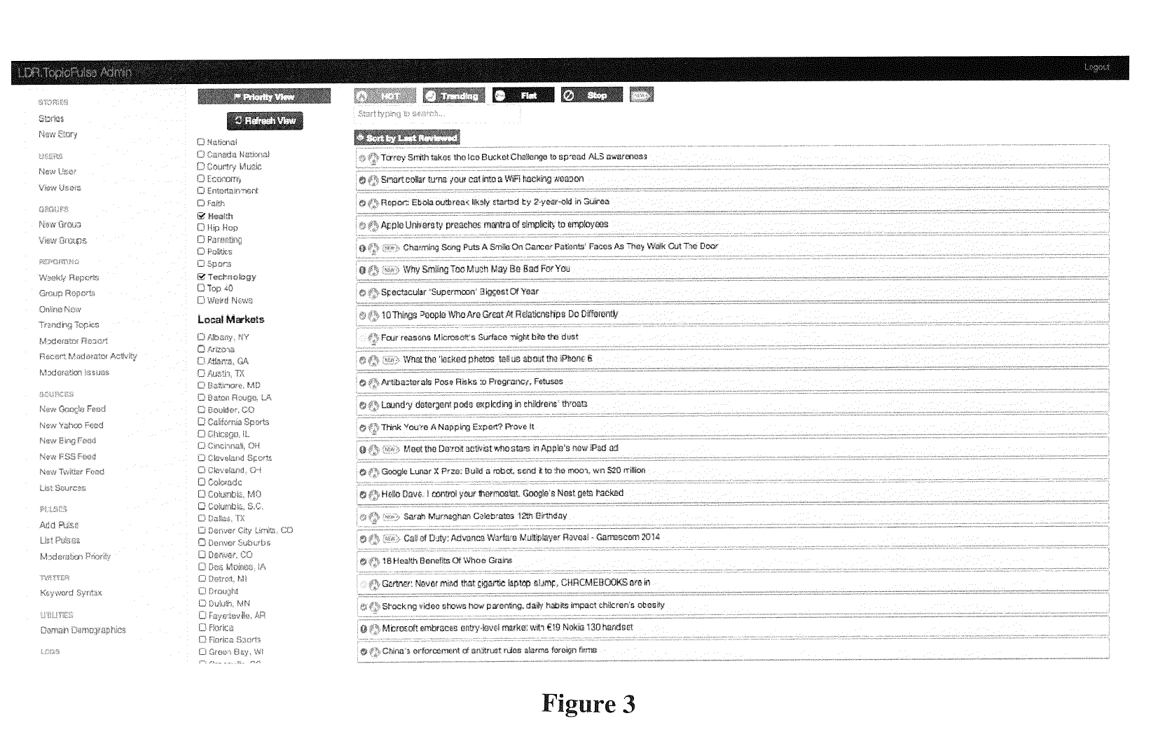

FIG. 4 is a schematic representation of the apparatus of the invention;

FIG. 5 illustrates an administrative screen of the present invention with a story dialog box which enables an administrator to re-categorize a story;

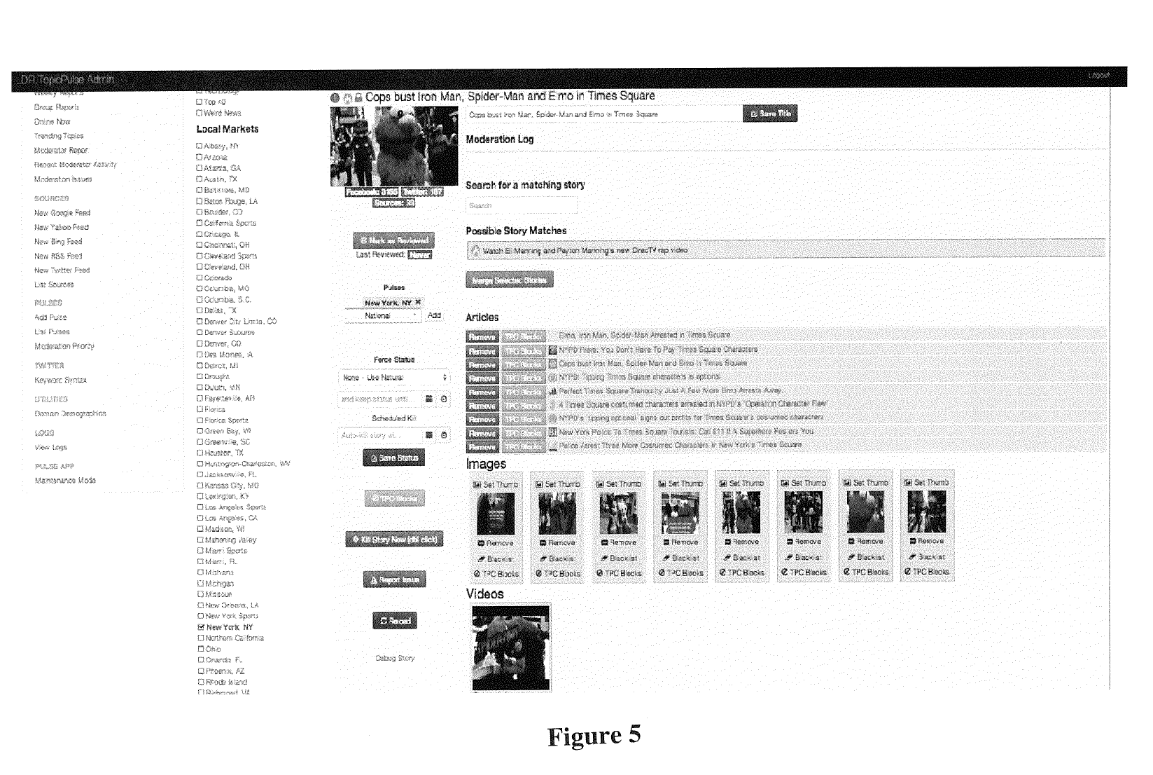

FIG. 6 illustrates a screen which enables the addition of an RSS Feed;

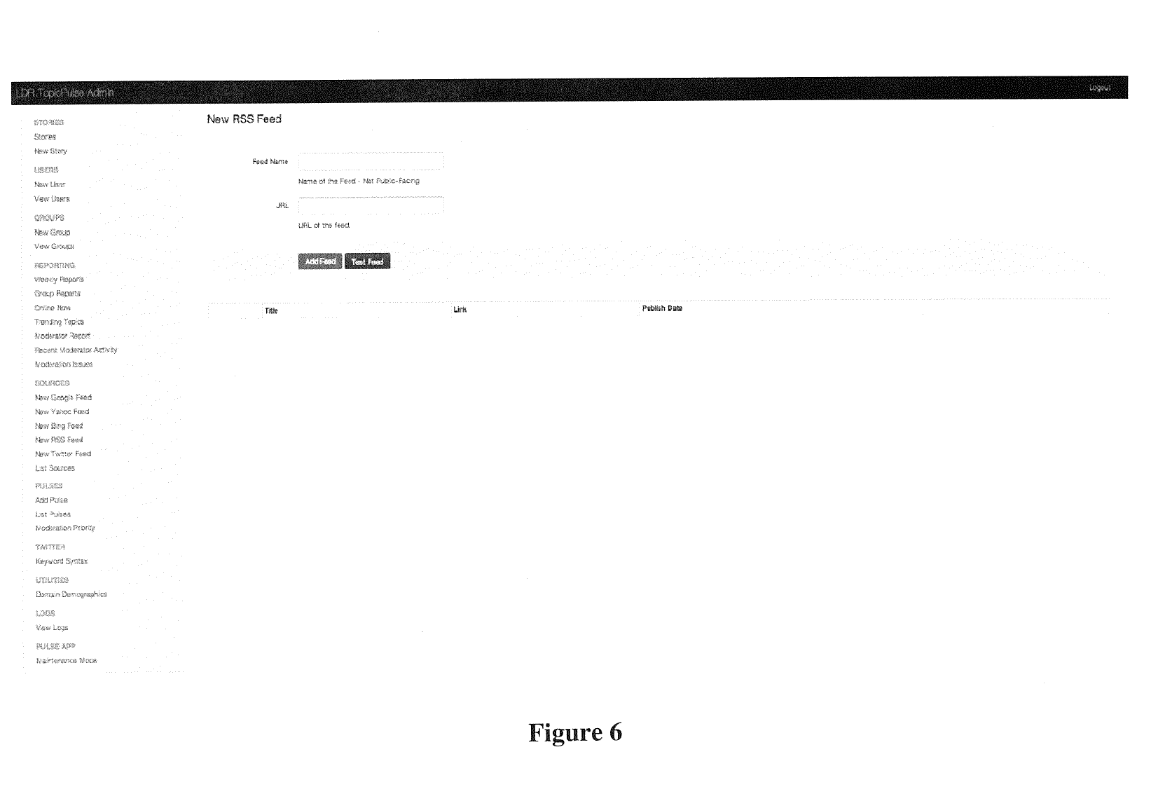

FIG. 7 illustrates a story pulse with a pulse graph dialog; and

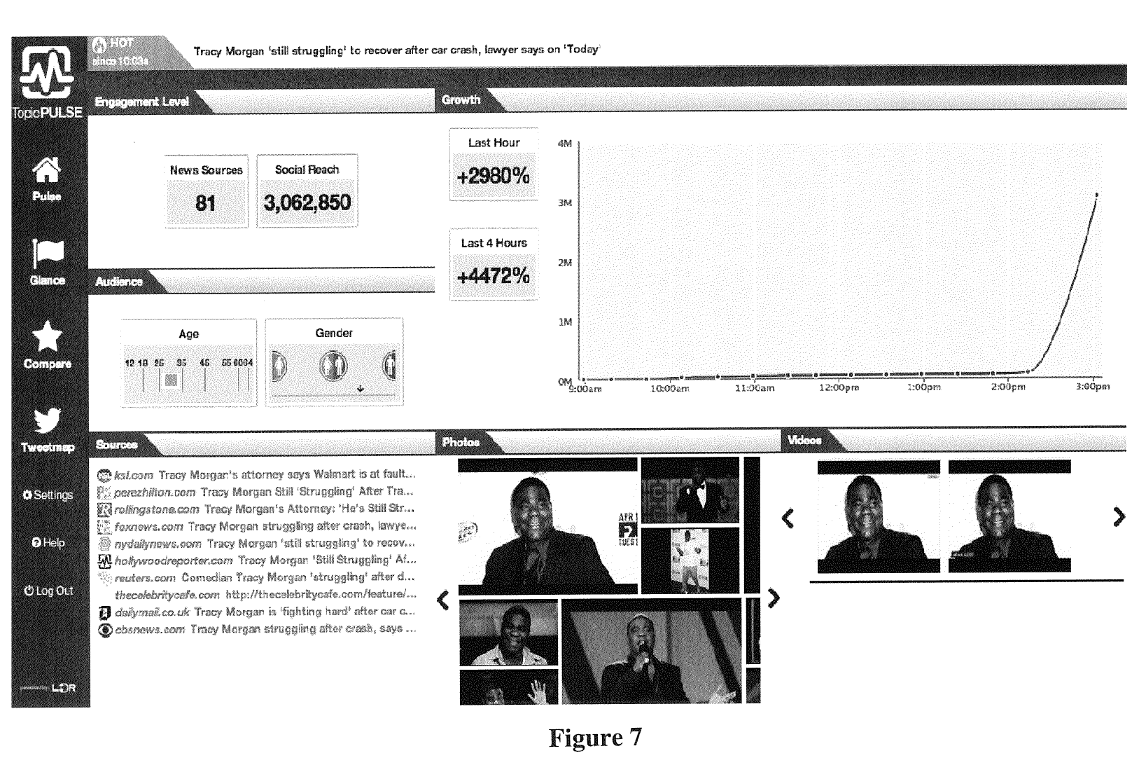

FIG. 8 illustrates the main Topic Pulse screen displaying the information in various colors.

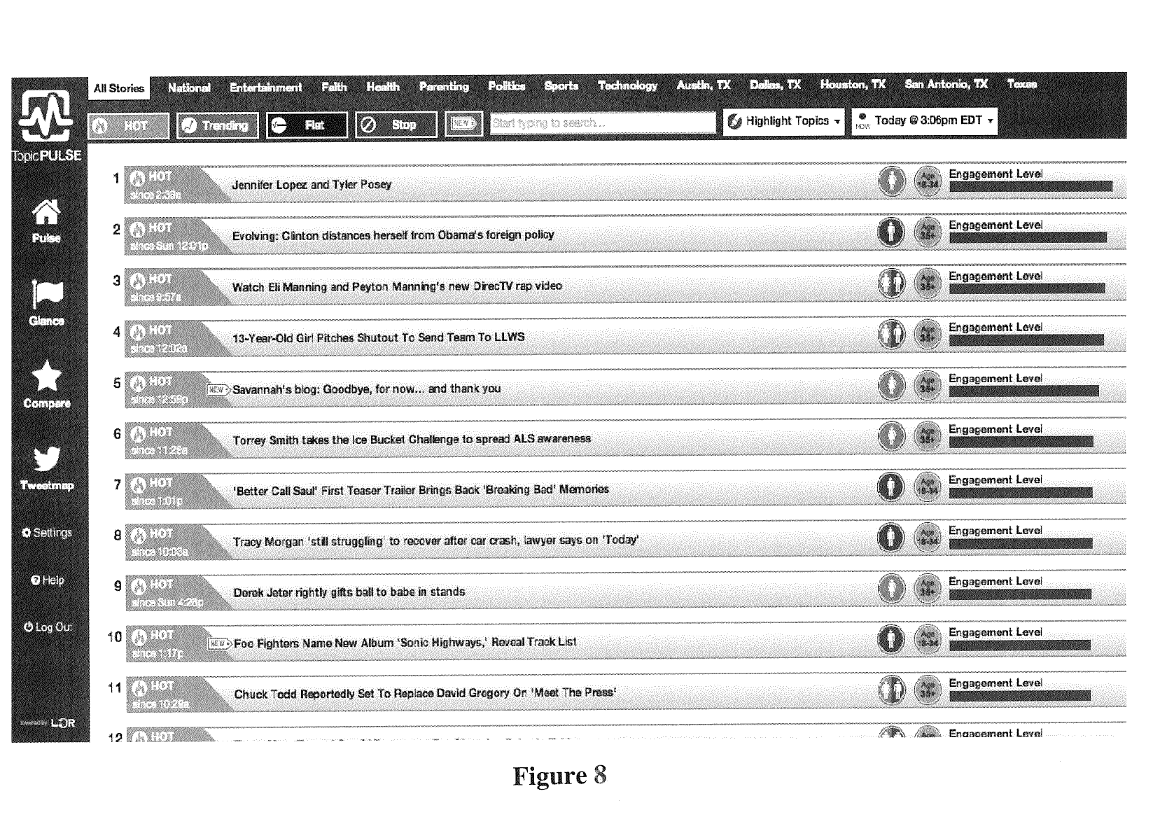

### DETAILED DESCRIPTION OF THE INVENTION

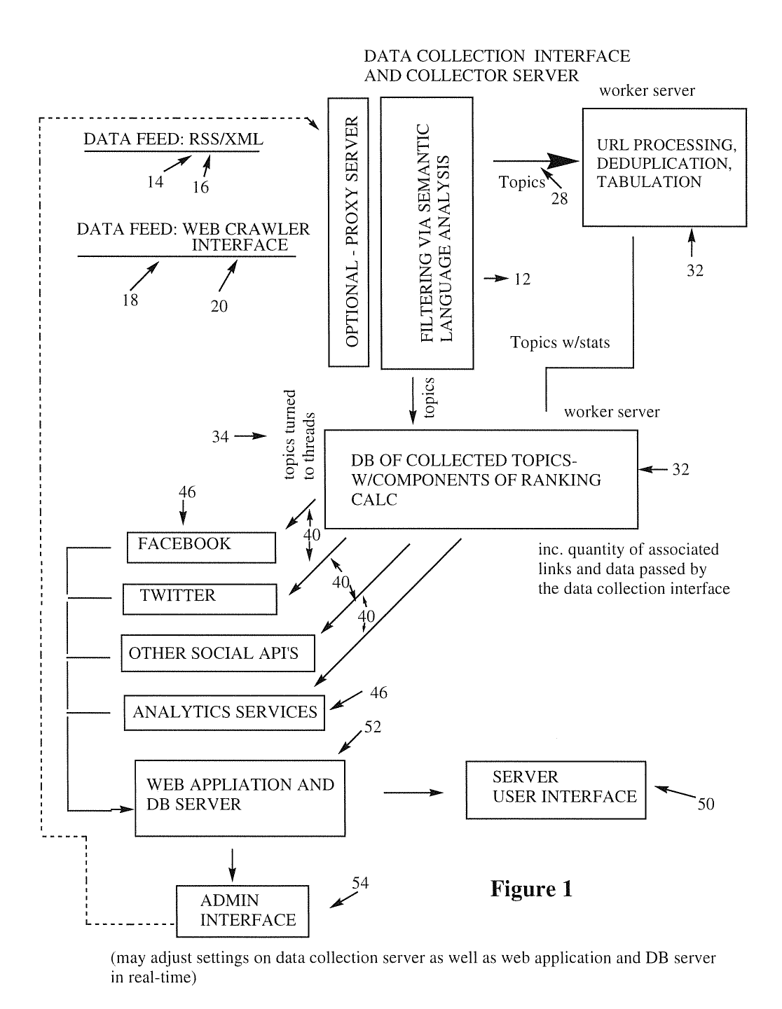

As shown in FIG. 1, the system 10 starts with a data collection interface and collector” server 12, which filters and aggregates a series of data feeds 14, including input from various RSS/XML feeds 16, and/or web feed 18. Additionally, the system can include a web crawler 20, which in this instance is a software program used in conjunction with computer hardware that automatically finds and downloads documents from host computers in networks such as the world wide web. The web crawler 20 is given a set of starting URL's, which it accesses to extract information according to a defined set of parameters. Then, the web crawler 20 downloads corresponding documents, extracts any URL's contained in those downloaded documents and downloads more documents using the newly discovered URL's. This process repeats indefinitely or until a predetermined stop condition occurs. The web crawler needs to be as efficient as possible in order to be able to process the volume of information that it may encounter. For example, as long ago as 1999 there were approximately 500 million web pages on the worldwide web and the number has grown exponentially since that time; thus, the provided web crawler will include an efficient data structures to keep track of downloaded documents and any discovered addresses of documents to be downloaded.

The data 28 collected from both data feed sources 16, 18 includes for example, news stories, headlines, blog entries, social media posts (e.g. tweets and comments), message board entries, and other similar data. This component of the system may optionally use a proxy server 29 to pull data feeds.

Data 30 from the collector server 12 is passed to a series of worker servers 32. The worker servers 32 use semantic language analysis 34 to merge data that appears to share a topic common-thread and to de-duplicate repetitive information. For example, “Movies seem to be getting more violent these days, but sell tickets” and “Violent movies are scoring high in the box office” would be merged from discrete stories or posts into one collective “thread” 36. Also, the worker servers 32 collect distinct URL's associated with each of the posts or stories. An example of the analysis that can be used to analyze the data is Latent Semantic Analysis (LSA), which is an unsupervised corpus-based statistical method that derives quantitative estimates of the similarity between words and documents from their contextual usage statistics. It is understood that other means of analysis can also be used, including for example, trademarks or tradenames, point of sale information or SKU numbers (in the context of a marketing or sales application for the present invention), or information based on the characteristics of the source, such as a pre-defined set of demographic characteristics of a web-site or social media user.

Further, some web publishers automatically shorten URL's shared in social media environments. (For example: http://www.history.com/topics/memorial-day-history has been shorted on Twitter to http://t.co/p0wwINHXec). In the event that a URL detected by the collector server 12 is a shortened URL (such as a bit.ly or t.co), the invention will look up the URL represented by the shortened address. Then, the original address is used in queries noted below. In addition, the worker servers can perform de-duplification and tabulation operations on the information that has been gathered. This results in a “topic” with statistics, which can be feed to a worker server to form a data base of collected topics with components of ranking, such as indications of the quantity of associated links and data passed by the data collection interface. At this point, the invention turns the “topics” into “threads”, which represents a collated stream of information based on a single topic gathered and evaluated in “real-time” meaning simultaneously (or so much as possible given the speed of the system) as the information is generated by the news source and social media. Further the system evaluates the information and/or interest “over-time” meaning repetitively at rep-defined intervals and for a pre-defined length of time, such as until the topic is no longer of interest.

Collated results representing multiple threads 40 are then used by the worker servers to automatically construct queries for social service API's 46 (e.g. Facebook® social graph and Twitter® API) and other analytics services. Using API calls and queries to these services, this server assesses how many times the URL's associated with each topic, post or story have been shared, retweeted, or referenced on the web. The queries may include parameters that qualify the type of sharing or characteristics of the user doing the sharing that was done for a topic. For instance, “how many women between ages 25-34 in the Cleveland metro area shared these keywords between 9am-10am on Monday and using what media, such as blog entries chat rooms, or social media. In addition, the server 42 uses an algorithm to estimate how much traffic or exposure a particular topic has received cumulatively.

The values obtained during this process are used to create and rank information relating to interest in the thread. Specifically, the invention determines an aggregated interest (e.g. a number of “hits” or requests to a web-server or file, or a file visit, view or query) at a specific time, i.e. the present, and further, the invention continues to collect information as previously defined so that the growth of interest in a thread or topic can be calculated. Further such as a “trend line,” which shows the velocity at which a particular topic has cultivated interest by a particular audience. The relationship is not seen as a linear relationship, but rather the interest is discounted for aging, and it is assumed that interest only grows since text and web-references remain in existence. However, it should be understood that the invention could be manipulated to account only for the change in interest which would allow for an increase or decrease in the value being considered.

Cumulative results of the queries processed by the worker servers 32 including data from the “trend line” are used by a Web Application and Database server 52 to produce a server user interface 50 where users can see a ranked list of the topics and stories detected by the system. In addition, these results can be feed to an administrative interface 54 to allow for adjustments on the data collection server 12 as well as the web application and data base server in real-time.

In the interfaces, 50, 54 users can see topics grouped by category or “pulses” as used herein, such as National, Entertainment, Sports, Politics, and Faith. Users can also see a ranked list of topics/stories in each of the categories along with a corresponding visual indicator, such as a color coded label. A “user” is a live or mechanical entity to whom or which the “pulsed” information is pushed by the invention, optionally as a visual display. A “user generated interaction” is an action or reaction which a “user” undertakes in the defined media in response to a topic. The rank and color coded label associated with each topic is determined using an algorithm that compares the rate of increase in social shares and web traffic associated with that particular topic over time. The components of the algorithm to determine the topic rank includes the following: the time that a topic is first detected at a current time; a minimum quantity of matching detections; the velocity of social mentions (for example on FaceBook®, Twitter® or other social media), the acceleration of social mentions over time; the cumulative quantity of social mentions such as “likes” or “dislikes” (which for this purpose are considered to be active user interactions that signify that a user has a positive or negative reaction to a topic; the velocity of news mentions or sources that refer to the topic; and the acceleration of the number of news sources. The algorithm also accounts for the aging of a topic or story. For instance, a topic must garner a higher level of sharing over time to keep up with the average level of sharing across all topics in the system. The algorithm is adjusted over time to reflect current market conditions. The user may hide stories or topics in the user interface if they desire to take the topic off the screen.

The invention can also automatically alert users via SMS text, e-mail, tweet, or other push mechanism when a topic in a particular category has been labeled by the system in a particular way (such as “hot” or “trending”). The invention also allows users to go backwards in time to a particular day or time period to observe which topics were trending during that time. The invention also measures and estimates how much of the story or topic's “buzz” is based on coverage from news media outlets vs. social media outlets. Users can see when a topic was first detected by the invention and how fast it has been growing. For most topics, users can also see a list of “most shared” URL's, making it easy for producers to research any particular topic on multiple sources—namely those that are getting shared most frequently by the audience measured by the system.

The user interface also includes a “Dashboard Screen” where users can view the topics that are trending up the fastest over the last hour, view the top stories in each category (i.e. Sports, Politics, etc.) at a glance, and see a window listing the topics that are “new” (i.e. have just been recently detected). The design of the “Dashboard Screen” is intended for (but not limited to) use on a monitor in a newsroom or content production team room which may be a “remote” display, meaning that it does not occur in the same physical location as the other components of the system are located.

The invention also may include a “Tweetmap” (based on a custom application or one that is commercially available) where tweets from a geographic area are collated and pasted against the backdrop of a geographic map to indicate where a particular topic is trending. In one such example, trends in this portion of the program are summarized with one word (the most prevalent keyword among all tweets measured), and the popularity of that trend is then symbolized by the font size of the word.

The system also has a web-based administrative control panel (or admin panel and which may be secure such as by firewall and other software and passcode protections), where an authorized administrator may make changes to which categories of topics are visible to each individual user on the system. The “administrator” is a set of instructions or person who is up-stream of the topic collecting and ranking process and has the ability to take control of this process, whereas a “user” is an entity or person downstream, who may participate in the social web-site or media based communications which are queried to determine interest or to whom the results of the inventive process (i.e. the ranking step) is fed. The web-based admin control panel also includes options to override the automatic merging of individual stories, where an administrative user may merge or un-merge certain stories out of a topic or otherwise manipulate the color-coded label associated with a topic.

In the web-based admin control panel, the administrator can also create new categories of topics or “pulses”, add new sources for the worker servers to crawl, pull from, or otherwise interface with. The administrator can also group individual users into a collective group, such as a broadcast station or web publisher (i.e. a common employer).

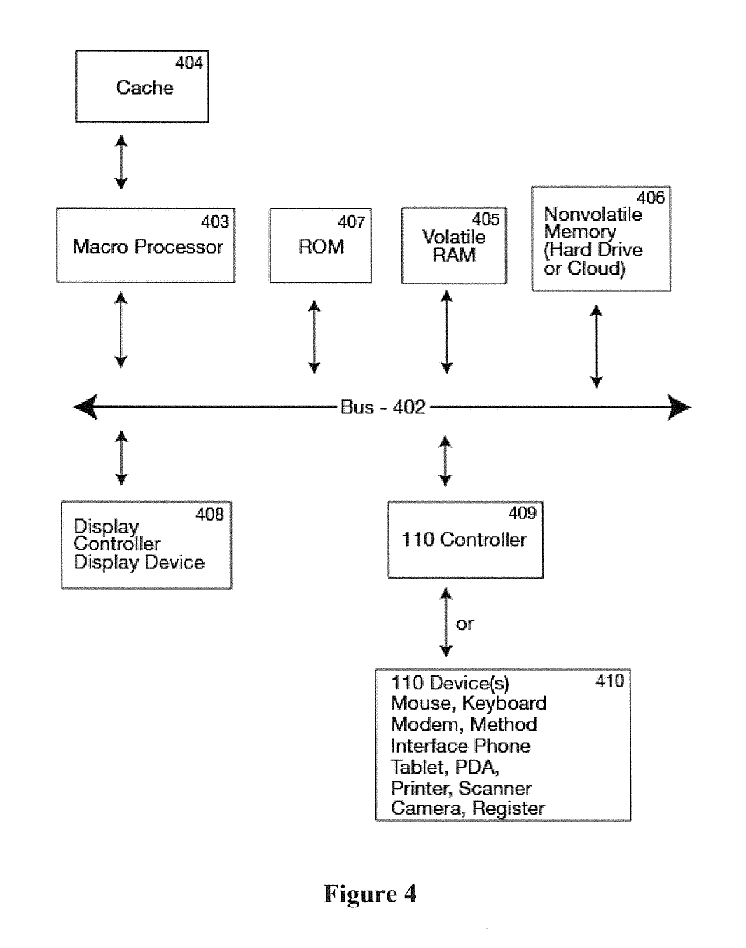

FIG. 4 illustrates an exemplary data processing system upon which the methods and apparatuses of the invention may be implemented. Note that while FIG. 4 illustrates various components of a data processing system, it is not intended to represent any particular architecture or manner of interconnecting the components. It will also be appreciated that network computers and other data processing systems, which have fewer or more components, may also be used. The data processing system of the present invention may, for example, be a workstation, or a personal computer (PC) running a Windows operating system, or an Apple Macintosh computer. As an example of the hardware with which the present invention can be used, the data processing system 401 includes a system bus 402 coupled to a microprocessor 403, a ROM 407, a volatile RAM 405, and a non-volatile memory 406. The microprocessor 403, which may be a processor designed to execute any instruction set, is coupled to cache memory 404. The system bus 402 interconnects these various components together and also interconnects components 403, 407, 405, and 406 to a display controller and display device 408, and to peripheral devices such as input/output (I/O) devices 410, such as keyboards, modems, network interfaces, printers, scanners, video cameras and other devices which are well known in the art. Typically, the I/O devices 410 are coupled to the system bus 402 through input/output controllers 409. The volatile RAM 405 is typically implemented as dynamic RAM (DRAM) which currently requires power continually in order to refresh or maintain the data in the memory. The non-volatile memory 406 is typically a magnetic hard drive or a magnetic optical drive or an optical drive or a DVD RAM or other type of memory systems which maintain data even after power is removed from the system. Typically, the non-volatile memory 406 will also be a random access memory although this is not required. While it is illustrated that the non-volatile memory 406 is a local device coupled directly to the rest of the components in the data processing system, the present invention may utilize a non-volatile memory which is remote from the system, such as a network storage device which is coupled to the data processing system through a network interface including for example through the “cloud”. The system bus 402 may include one or more buses connected to each other through various bridges, controllers and/or adapters. The I/O controller 409 may include a USB (Universal Serial Bus) adapter for controlling USB peripherals, and/or an IEEE-bus adapter for controlling IEEE-peripherals.

It will be apparent from this description that aspects of the present invention may comprise in software, hardware, firmware, or in combination thereof. Further, the invention may be executed using a computer system, tablet, PDA, phone, television or other data processing system in response to its processor, such as a microprocessor, executing sequences of instructions contained in a memory, such as ROM 407, volatile RAM 405, non-volatile memory 406, cache 404, or a remote device. In various embodiments, hardwired circuitry may be used in combination with software instructions to implement the present invention. Thus, the invention is not limited to any specific combination of hardware circuitry and software or to any particular source for the instructions executed by the data processing system. In addition, throughout this description, various functions and operations are described as being performed by or caused by software or by hardware so as to simplify description. However, it will be understood that the functions result from execution of code by a processor, such as a microprocessor.

The invention also relates to the aggregated apparatus for performing the operations of the invention. This apparatus may be specially constructed for the invention, or it may comprise a general purpose computer selectively activated or reconfigured by a computer program stored in the computer. This computer program may be stored or transmitted in a computer-readable medium which can be used to store software and data which when executed by a data processing system, such as data processing system, causes the system to perform the various tasks of the present invention. This executable software and data may be stored in various places including for example ROM 407, volatile RAM 405, non-volatile memory 406, and/or cache 404 as is illustrated. All or part of this software and/or data may be stored in any one of these storage devices. A computer-readable medium may include any mechanism that collects or provides (including for example, storing and/or transmitting) information in a form accessible by a machine such as for example, a computer, network device, personal digital assistant, tablet, phone, manufacturing tool, camera, or any device with a set of one or more processors. For example, a machine readable medium includes recordable/non-recordable media such as, but not limited to, a computer-readable storage medium (e.g., any type of disk including floppy disks, optical disks, CD-ROMs, and magnetic-optical disks, read-only memories (ROMs), random access memories (RAMs), EPROMs, EEPROMs, flash memory, magnetic or optical cards, or any type of media suitable for storing electronic instructions), or a computer-readable transmission medium such as, but not limited to, any type of electrical, optical, acoustical or other form of propagated signals (e.g., carrier waves, infrared signals, digital signals, etc.).

Additionally, it will be understood that the various embodiments described herein may be implemented with data processing systems which have more or fewer components than the illustrated system. For example, such data processing systems may include a cellular telephone or a personal digital assistant (PDA) or an entertainment system or a media player or a consumer electronic device, each of which can be used to implement one or more of the embodiments of the invention. The algorithms and displays presented herein are not inherently related to any particular computing system or other apparatus. Various general purpose systems may be used with programs in accordance with the teachings herein, or it may prove convenient to construct custom apparatuses to perform the method operations. In addition, a variety of programming languages, structure and techniques may be used to implement the teachings of the invention as described herein.

Some portions of the detailed description as set forth above are presented in terms of algorithms and symbolic representations of operations on data bits within a computer memory. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood that throughout the description, discussions utilizing terms such as “scanning” or “filtering” or “calculating” or “collecting” or “tabulating” or “categorizing” “ranking” or “displaying”, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices and which enables the further use such as by visual display.

The invention may include various operations as set forth above or more or fewer operations in an order which is different from the order described herein so long as the end purpose can be attained. The described operations may be provided in machine-executable instructions, which cause a general-purpose or special-purpose processor to perform certain tasks. Alternatively, these operations may be performed by hardware components that contain hardwired logic for performing the operations, or by any combination of programmed computer components and custom hardware components.

In accordance with the patent statutes, the best mode and preferred embodiment have been set forth; the scope of the invention is not limited thereto, but rather by the scope of the attached claims.

What is claimed is:

1. A method for detecting interest in a topic comprising the steps of:
using a computer having the hardware and software to use grouping analysis to group multiple versions of the topic into one thread;
using a computer having the hardware and software to query various social media services or web services to quantify the number of interactions at a given time related to the thread; and
using a computer having the hardware and software to repeat the query over time to identify and tabulate interest in the thread among an audience and form a summary of the interest tabulation to indicate a level of interest in the topic and further to categorize the level of interest, and display the summary visually and use a visual or audio indicator to indicate the level of real-time interest over time.

2. The method for detecting interest in a topic as set forth in claim 1, wherein there are a plurality of topics and a plurality of threads and further including the step of grouping the topics or threads according to a defined matrix of characteristics defined as “pulses”.

3. The method for detecting interest in a topic as set forth in claim 1, wherein the grouping analysis is a semantic analysis.

4. The method for detecting interest in a topic as set forth in claim 1, wherein the interactions comprise user generated actions.

5. The method for detecting interest in a topic as set forth in claim 4, wherein the user generated actions comprise one or more of “likes”, “posts”, “texts”, “comments” “traffic” and “tweets.”

6. The method for detecting interest in a topic as set forth in claim 4, wherein word analysis is used to evaluate if the topic is positively or negatively perceived.

7. The method for detecting interest in a topic as set forth in claim 1, further including the step of using an administrative screen to enable the input of parameters relating to the system.

8. The method for detecting interest in a topic as set forth in claim 8, wherein where the audience can be a particular group according to pre-defined characteristics comprising demographics or psychographics.

9. The method for detecting interest in a topic as set forth in claim 1, wherein the level of interest is categorized into a plurality of categories.

10. The method for detecting interest in a topic as set forth in claim 9 wherein, the level of interest ranks one or more of the cumulative interest in a topic, the growth of interest in a topic, the decline of interest in a topic, and the rate of growth of interest in a topic.

11. The method for detecting interest in a topic as set forth in claim 1, wherein the summary is displayed remotely.

12. The method for detecting interest in a topic as set forth in claim 1, wherein the indicator includes as a color coding label or audible alarm.

13. The method for detecting interest as set forth in claim 2, wherein the type of topic is defined by a metro survey area.

14. The method for detecting interest as set forth in claim 13, wherein the type of topic includes one or more of national, entertainment, sports, politics, technology, science, fashion, news market.

15. A method for detecting interest in a topic comprising the steps of:
using a news source to determine a topic
using a computer having the hardware and software to use semantic analysis to group multiple versions of the topic or story into one thread;
using a computer having the hardware and software to repetitively query various social media services and web services to quantify the number and type of user generated interactions relating to the topic at a given time related to the thread; and
using a computer having the hardware and software to identify and to tabulate interest in the thread among a defined audience and to form a summary of the interest tabulation to indicate and rank a level of interest in the thread and further to categorize the level of interest, and display the summary visually using color coding to indicate the level interest in the thread.

16. A system for detecting interest in a topic comprising:
a computer having the hardware and software to use grouping analysis to group multiple versions of the topic or into one thread;
a computer having the hardware and software to query various social media services or web services to quantify the number of interactions at a given time related to the thread; and
a computer having the hardware and software to repeat the query over time to identify and tabulate interest in the thread among an audience and form a summary of the interest tabulation to indicate a level of interest in the topic and further to categorize the level of interest, and to display the summary visually and use a visual or audio indicator to indicate the level of real-time interest over time.

17. A system for detecting interest in a topic as set forth in claim 16, wherein there are a plurality of topics and a plurality of threads and further including the step of grouping the topics or threads according to a defined matrix of characteristics defined as “pulses”.

18. A system for detecting interest in a topic as set forth in claim 17, wherein the grouping analysis is a semantic analysis

19. The system for detecting interest in a topic as set forth in claim 16, wherein the interactions comprise user generated actions.

20. The system for detecting interest in a topic as set forth in claim 19, wherein the user generated actions comprise one or more of “likes”, “posts”, “comments”, “traffic”, “texts” and “tweets.”

21. The system for detecting interest in a topic as set forth in claim 19, wherein word analysis is used to evaluate if the topic is positively or negatively perceived.

22. The method for detecting interest in a topic as set forth in claim 16, further including the step of using an administrative screen to enable the input of parameters relating to the system.

23. The system for detecting interest in a topic as set forth in claim 16, wherein where the audience can be a particular group according to pre-defined characteristics comprising demographics or psychographics.

24. The system for detecting interest in a topic as set forth in claim 16, wherein the level of interest is categorized into a plurality of categories.

25. The system for detecting interest in a topic as set forth in claim 24, wherein the level of interest ranks one or more of the cumulative interest in a topic, the growth of interest in a topic, the decline of interest in a topic, and the rate of growth of interest in a topic.

26. The system for detecting interest in a topic as set forth in claim 16, wherein the summary is displayed remotely.

27. The system for detecting interest in a topic as set forth in claim 16, wherein the indicator includes a color coding label or audible alarm.

28. The system for detecting interest as set forth in claim 17, wherein the type of topic is defined by a metro survey area.

29. The system for detecting interest as set forth in claim 16, wherein the type of topic includes one or more of national, entertainment, sports, politics, technology, science, fashion, news market.

30. The system for detecting interest in a topic as set forth in claim 16, further including an input/output device having an administrative screen to enable the input of parameters relating to the system.

31. A system for detecting interest in a topic comprising the steps of:
a computer having the hardware and software to use semantic analysis to group multiple versions of the topic as determined by a news source into one thread;
a computer having the hardware and software to repetitively query various social media services and web services to quantify the number and type of user generated interactions relating to the topic at a given time related to the thread; and
a computer having the hardware and software to identify and to tabulate interest in the thread among a defined audience and to form a summary of the interest tabulation to indicate and rank a level of interest in the thread and further to categorize the level of interest, and display the summary visually using color coding to indicate the level interest in the thread.

32. The system for detecting interest in a topic as set forth in claim 16, further including an input/output device having an administrative screen to enable the input of parameters relating to the system.
